(19) United States
(12) Patent Application Publication
(10) Pub. No.: US 2011/0022680 A1
(43) Pub. Date: Jan. 27, 2011

(54) CONTENT DISTRIBUTION SYSTEMS AND METHODS

(76) Inventor: Moses Johnson, Phildelphia, PA (US)

Correspondence Address: BLACK LOWE & GRAHAM, PLLC, 701 FIFTH AVENUE, SUITE 4800, SEATTLE, WA, 98104, US

(21) Appl. No.: 12/767,661

(22) Filed: Apr. 26, 2010

Related U.S. Application Data
(60) Provisional application No. 61/172,286, filed on Apr. 24, 2009.
(60) Provisional application No. 61/174,552, filed on May 1, 2009.

(51) Int. Cl. G06F 15/16

(52) U.S. Cl. 709/217

(57) ABSTRACT

Various embodiments facilitate the distribution of digital content. In some embodiments, a system manages the distribution of a subscription that includes digital content. In one embodiment, the system pushes the subscription to a first and second portable computing device. Then, the system receives from the first portable device a user addition to the subscription, such as some new or changed text. Next, the system incorporates the received addition into the subscription to the first and second portable devices. In another embodiment, the system receives a customization request, composes a subscription based on guidelines in the received request, and pushes the subscription to a portable device.

### PRIORITY CLAIM

This application claims the benefit of U.S. Provisional Application No. 61/172,286, filed on Apr. 24, 2009 and entitled “Interactive Digital Media,” and U.S. Provisional Application No. 61/174,522, filed on May 1, 2009 and entitled “Interactive Digital Media,” both of which are incorporated herein by reference in their entireties.

### FIELD OF THE INVENTION

The field of the invention is interactive media, and more particularly the distribution of digital content and the incorporation of user-provided additions thereto, as well as the generation and distribution of customized digital content according to user-specified guidelines.

### BACKGROUND

In printed journalism such as magazines and newspapers, readers can interject ideas or opinions through opinion sections. However, publications typically print such comments in the following issue, by which time the issues to which the comments refer typically have been forgotten or are no longer material.

With the growth of the Internet, traditional journalism evolved into online journalism, which allows readers' viewpoints and ideas to be quickly published. However, such online journalism fails incorporate such viewpoints, and the readers' viewpoints become mere afterthoughts to an article rather than an extension of it.

To provide a forum for users to incorporate their thoughts and ideas into an article or other form of online journalism, websites such as the online encyclopedia Wikipedia (see http://www.wikipedia.org) allow users to modify existing content and have their modifications incorporated within the content. However, such sites generally require a user to actively retrieve content and are often difficult to navigate on portable devices such cellular phones.

Similarly, U.S. Pat. No. 6,052,717 to Reynolds, et al. discusses an interactive web book system that allows users to contribute to the book material. One problem with such system is that the material must be requested or “pulled” by a user, rather than pushed to a user's device. Such system can also be problematic with a portable media device such as a cellular telephone, as the device often has limited Internet access and browsing capabilities, which often prohibits a user from accessing such material.

In an attempt to provide for interactive digital content, U.S. Pat. No. 7,069,579 to Depulch discusses an on-demand interactive magazine, such as to be viewed on a television screen. While a user can navigate the content, the user lacks the ability to submit user additions to the content. Thus, the user is confined to passively view the content.

Another problem with traditional printed media relates to customizability. Traditionally, publishers of printed periodicals such as magazines and newspapers determine which content is published and presented to readers. While a portion of the content might vary depending on various factors such as geographical location, readers lack any ability to customize the periodical. Thus, for example, readers of a newspaper who read only the sports section will still receive the other sections of the newspaper. This is disadvantageous as it increases the cost of publication and delivery of the newspaper to readers who only desire a single section. In addition, because the periodical generally provides a wide range of content, the depth of the articles or topics often decreases.

Depulch, referenced above, discusses an on-demand interactive magazine, such as to be viewed on a television screen. While a reader can navigate the content, readers lack any ability to customize the magazine based upon each reader's interests. Thus, readers must navigate the periodical to reach their desired topics.

In addition, various “portals” or other aggregating web sites have emerged which allow readers to select topics and areas of interest and thereby customize the information displayed. Thus, for example, a reader can select “sports,” “weather,” and “business” news, and have the relevant information presented in a single location. One problem with this solution is that readers must actively go to the web site and request or “pull” the information. This can be problematic, especially on portable media devices such as cellular phones that have limited ability to navigate the Internet.

### SUMMARY

In one embodiment, a method of distributing digital content to a plurality of users is provided. The method includes receiving a first customization request from a first portable device, and receiving a second customization request from a second portable device; composing a first subscription according to guidelines of the first customization request; composing a second subscription according to guidelines of the second customization request, wherein the first and second subscriptions have at least some common content; pushing the first subscription to the first portable device, and pushing the second subscription to a second portable device; receiving from the first portable device a first user addition to the first subscription; incorporating the first user addition into the first and second subscriptions and producing a revised first subscription and a revised second subscription; and pushing the revised subscriptions to the first and second portable devices.

In another embodiment, a method for distributing digital content to a plurality of users is provided. The method includes pushing a subscription to a first portable device and a second portable device; receiving from the first portable device a first user addition to the subscription; incorporating the first user addition into the subscription and producing a revised subscription; and pushing the revised subscription to the first and second portable devices.

In a further embodiment, a method of distributing customized digital content to a plurality of readers is provided. The method includes receiving a first customization request from a first reader, and receiving a second customization request from a second reader; composing a first and second subscription according to guidelines of the first and second customization requests, respectively; and pushing the first subscription to a first portable device, and pushing the second subscription to a second portable device.

In another embodiment, a computing system configured to distribute digital content is provided. The computing system includes a module that is stored on a memory and that is configured, when executed, to perform operations similar to those of the above-described method.

In a further embodiment, a computer-readable storage medium is provided. The computer-readable storage medium includes contents that, when executed, perform operations similar to those of the above-described method.

### BRIEF DESCRIPTION OF THE DRAWINGS

Preferred and alternative examples of the present invention are described in detail below with reference to the following drawings:

FIG. 1 illustrates a block diagram of an example embodiment of a subscription management system.

FIG. 2 is a block diagram of an example computing system for implementing a subscription management system according to an example embodiment.

FIG. 3 is a flow diagram of a subscription management process performed by a first example embodiment.

FIG. 4 is a flow diagram of a subscription management process performed by a second example embodiment.

### DETAILED DESCRIPTION

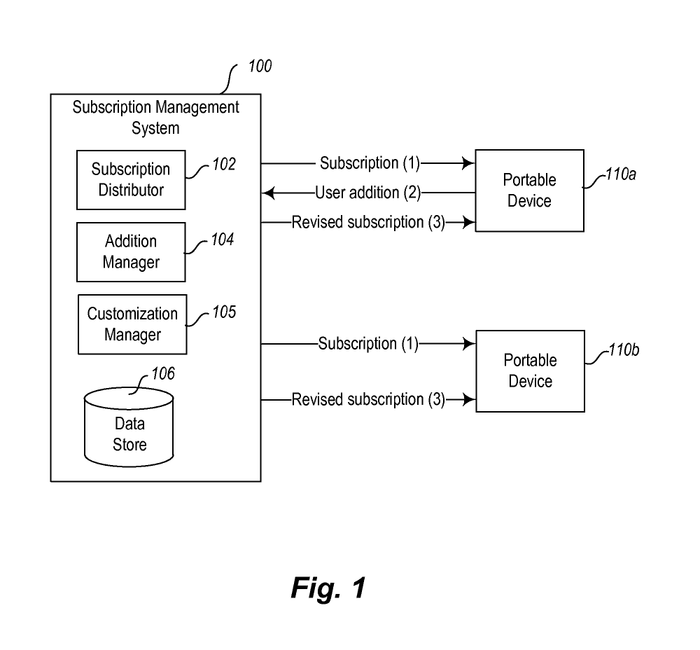

FIG. 1 illustrates a block diagram of an example embodiment of a subscription management system. In particular, FIG. 1 shows a subscription management system 100 distributing digital content to two portable devices 110a and 110b that are each operated by a corresponding user (not shown). The subscription management system 100 includes a subscription distributor 102, an addition manager 104, a customization manager 105, and a data store 106.

In one embodiment, the subscription management system 100 facilitates the incorporation of user-provided additions to subscription content, as described next.

Initially, the subscription management system 100 distributes digital content stored in the data store 106 by pushing a subscription to the first and second portable devices 110a and 110b. As used herein, the term “subscription” is defined as digital content purchased, licensed, or subscribed to by a user, including magazines, articles, and other digital content. The subscription could include text, audio, video, and/or interactive content (e.g., program code). Preferably, such content is produced similarly to a printed magazine using incorporates journalistic standards such as those by the Society of Professional Journalists (see http://www.spj.org/ethicscode.asp). Contemplated portable devices 110 include cellular telephones, personal digital assistants (PDAs), portable media readers/players, tablet computers, and the like.

Similarly to the differences between having a newspaper delivered and purchasing it at a newsstand, content that is pushed to a user requires no additional action from the user to receive it. Pushing content to a portable device is advantageous, as it allows the content to be automatically updated without any action required of the user. Thus, a user can view additions to a subscription without any need to constantly search and retrieve updates, etc. Furthermore, for a subscription such as a magazine, pushing the content allows the user to receive the latest issues without having to remember to search and download it. In contrast, content pulled from a server requires a user or intermediary to actively search for the content and/or any revisions, which the user can then elect to download.

After receiving the subscription as described above, a first user operating portable device 110a communicates a first user addition to the subscription. The addition could be any modification to the content including deletions, additions and/or substitutions. The addition may include text or other content (e.g., audio) that indicates or otherwise describes the addition. Preferably, the first user addition is communicated to a remote server, such as the subscription management system 100, either directly or indirectly.

Once received at the subscription management system 100, the addition manager 104 reviews and either rejects or incorporates the addition into the subscription. Such a review process is advantageous, as it allows for the addition to be reviewed for content, and thereby ensures the integrity of the subscription. Additions might be rejected for various reasons including, for example, accuracy, fairness, falsehoods, offensive or disparaging language, or plagiarism. It is also contemplated that a user addition might be modified before being incorporated into the subscription, such as to correct typographical errors and inconsistencies, or to blend the addition into the subscription.

In some embodiments, the review process is totally or partially automatic. For example, an addition may be automatically (e.g., without human intervention) checked for disparaging language (e.g., by searching for disparaging terms) or plagiarism (e.g., by performing searches of public or private data sources for key terms or phrases from the addition). In other embodiments, humans perform at least some of the review process, such as copy editing, fact checking, and the like.

If the addition is incorporated into the subscription, a revised subscription is produced, which is stored in the data store 106 and pushed to the first and second portable devices 110a and 110b. Optionally, an acknowledgement or citation to the first user could be included in the revised subscription to credit the first user with the first user addition.

In some cases, the entire revised subscription need not be pushed to the first and second portable devices 110a and 110b. For example, some embodiments push only the difference (e.g., delta) between the original subscription and the revised subscription, leaving it to the portable device to perform the assembly of the revised subscription by incorporating the difference into the original subscription. Such an approach advantageously conserves network bandwidth and decreases latency, particularly when the user additions are small with respect to the size of the subscription.

In another embodiment, the subscription management system 100 provides customized subscriptions based on user-specified guidelines, as described next.

Initially, the customization manager 105 of the subscription management system 100 receives a first customization request from the first portable device 110a, and receives a second customization request from the second portable device 110b. The portable devices 110a and 110b are each operated by a corresponding user reader (not shown). As used herein, the term “guidelines” is defined as one or more areas or topics of interest of a reader, including for example, content relating to a geographical location (e.g., within a city, a county, a state, or defined distance from a location), topics (e.g., sports, music, business, movies, technology, etc.), authors, and/or any combinations thereof. It is also contemplated that readers could further customize the subscription within an area of interest. Thus, for example, a reader could select one or more genres within “music” to further restrict the content to those genres. This is advantageous as it allows readers to receive only the content that interests them, and allows publishers to better understand and provide for the interests of their readers.

The customization requests received by the customization manager 105 allow readers to specify the content of the subscription pushed to the portable device. Preferably, the portable device of the reader includes a software interface that allows the reader to select areas or topics of interest to allow the subscription to be customized for each reader. However, any suitable interface that allows a reader to customize a subscription can be utilized in conjunction with the subscription management system 100, including for example, telephone interfaces (e.g., live operators or touch-tone interfaces), computer interfaces, Web-based interfaces, and/or any combination thereof. Selected areas or topics of interest are incorporated into the customization request as guidelines.

After the first and second customization requests are received, the customization manager 105 composes a first subscription and a second subscription according to the guidelines of the respective received customization requests. Then, the subscription manager 102 pushes the first and second subscriptions to the portable devices 110a and 110b, respectively.

The above approach is advantageous in that it allows a subscription that is pushed to a reader to be customized to the reader's interests. Typically, the first subscription will contain at least some differences in components (i.e., content) than the second subscription. However, it is possible that the first and second customization requests could comprise the same guidelines, and therefore the first and second subscriptions could be identical.

In one aspect, the first reader updates the first customization request by selecting or deselecting one or more areas of interest. The updated first customization request is received by the customization manager 105 from the first reader via the first portable device 110a and an updated first subscription is pushed to the first portable device 110a. Thus, as the interests of a reader changes, the content of the subscription can also change, and the updated subscription is automatically pushed to the reader.

In preferred embodiments, each of the first and second users/readers can determine how frequently to receive updates and/or new issues for each subscription. Contemplated settings would allow a reader to designate to receive the updates as they become available, or at defined time intervals (e.g., every day, every week, etc.). Preferably, software loaded on the portable devices allows readers to change such settings.

In some embodiments, the above-described techniques for managing user-provided additions can be used in conjunction with the above-described techniques for providing customized content. For example, the customization manager 105 may compose a first and second subscription according to guidelines in respective first and second customization requests. In some cases, the first and second subscriptions will have at least some content in common, such as, in the context of a newspaper, the national news. Later a user operating the first portable device 110a may submit an addition to the common portion of the subscription. In response, the addition manager 104 incorporates the received addition into the first and second subscriptions to generate revised first and second subscriptions, and causes the subscription distributor 102 to push the revised first and second subscriptions to the respective portable devices 110a and 110b.

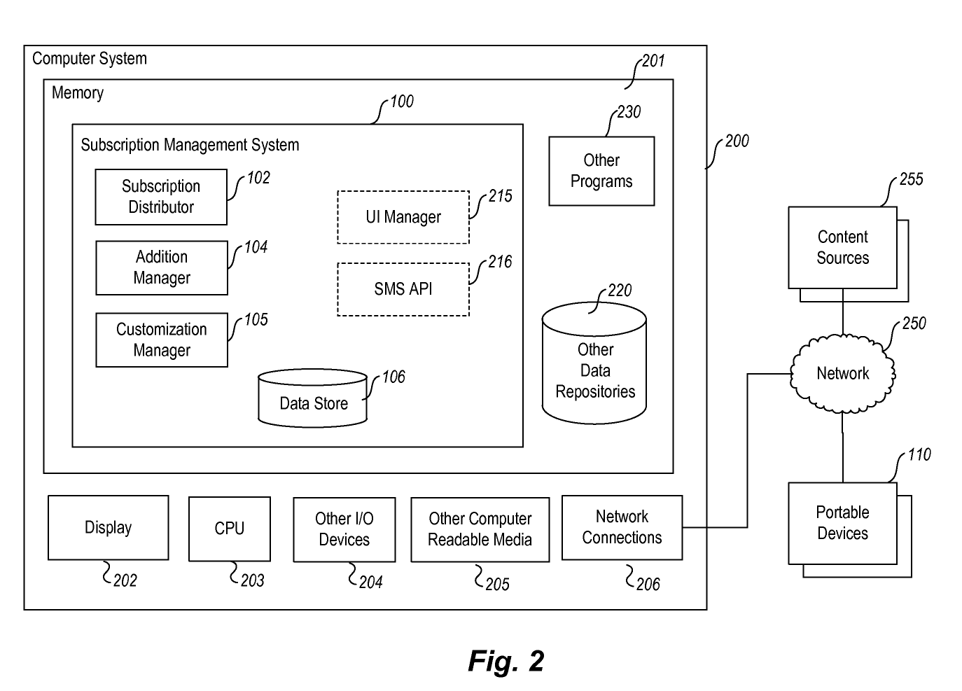

As discussed further with reference to FIG. 2, below, preferred embodiments utilize one or more servers to host the digital content, user additions, and customization requests. Software running on at least one server or separate device pushes the subscription to subscribed users using one or more networks and/or accesses each customization request, and pushes the customized subscription to the specific reader using one or more networks. Contemplated network connections include wired connections, wireless connections (e.g., WIFI, Bluetooth, cellular networks, etc.), and combinations thereof. Preferably, the content is downloaded to and stored on the portable devices 110a and 110b. This is advantageous as it allows the user to read the content in situations lacking network connections (e.g., an airplane or the subway).

Preferably, software present on the portable devices 110a and 110b allows readers to navigate subscriptions. In addition, the software may include a built-in media player to allow users to watch video or listen to audio in a subscription. Preferably, such audio/video is pushed to the portable devices with the subscription. However, it is also contemplated that the audio/video could be streamed to the portable device upon demand.

FIG. 2 is a block diagram of an example computing system for implementing a subscription management system according to an example embodiment. In particular, FIG. 2 shows a computing system 200 that may be utilized to implement the subscription management system 100.

Note that one or more general purpose or special purpose computing systems/devices may be used to implement the subscription management system 100. In addition, the computing system 200 may comprise one or more distinct computing systems/devices and may span distributed locations. Furthermore, each block shown may represent one or more such blocks as appropriate to a specific embodiment or may be combined with other blocks. Also, the subscription management system 100 may be implemented in software, hardware, firmware, or in some combination to achieve the capabilities described herein.

In the embodiment shown, computing system 200 comprises a computer memory (“memory”) 201, a display 202, one or more Central Processing Units (“CPU”) 204, Input/Output devices 204 (e.g., keyboard, mouse, CRT or LCD display, and the like), other computer-readable media 205, and network connections 206. The subscription management system 100 is shown residing in memory 201. In other embodiments, some portion of the contents, some or all of the components of the subscription management system 100 may be stored on and/or transmitted over the other computer-readable media 205. The components of the subscription management system 100 preferably execute on one or more CPUs 203 and manage subscriptions as described herein. Other code or programs 230 (e.g., an administrative interface, a Web server, and the like) and potentially other data repositories, such as data repository 220, also reside in the memory 201, and preferably execute on one or more CPUs 203. Of note, one or more of the components in FIG. 2 may not be present in any specific implementation. For example, some embodiments may not provide other computer readable media 205 or a display 202.

As discussed above, the subscription management system 100 includes a subscription distributor 102, an addition manager 104, a customization manager 105, and a data store 106. The subscription management system 100 may also include a user interface manager 215 and a subscription management system application program interface (“API”) 216. The UI manager 215 and API 216 are drawn in dashed lines to emphasize that in other embodiments, functions performed by one or more of these components may be performed externally to the subscription management system 100.

As noted above, the subscription distributor 102 pushes or otherwise transmits subscriptions to one or more portable devices 110 via a network 250. In addition, the subscription distributor 102 may perform content acquisition functions, such as by obtaining content from one or more content sources 255 via the network 250. The obtained content is stored in the data store 106. In some embodiments, the system 100 operates as a service utilized by various content sources/producers (e.g., news entities) to manage the distribution of their content. In addition, the subscription distributor 102 may perform user/account management functions, such as by tracking users or devices that are associated with particular subscriptions.

The addition manager 104 manages user-supplied additions to subscriptions. In particular, this may include receiving an addition from one of the portable devices 110, possibly reviewing and/or editing the addition, and then producing a revised subscription based on the original subscription and the received addition. The revised subscription is stored in the data store 106 for distribution by the subscription distributor 102.

The customization manager 105 manages user-specified customizations. In particular, this may include receiving from one of the portable devices 110 a customization including one or more guidelines, composing a subscription according to the received guidelines, and causing the subscription distributor 102 to push the composed subscription to the originating portable device 110.

The UI manager 215 provides a view and a controller that facilitate user interaction with the subscription management system 100 and its various components. For example, the UI manager 215 may provide interactive access to the subscription management system 100, such that users can obtain subscriptions, submit additions, specify customizations, and the like. In some embodiments, access to the functionality of the UI manager 215 may be provided via a Web server, possibly executing as one of the other programs 230. In such embodiments, a user operating a Web browser executing on one of the portable devices 110 can interact with the subscription management system 100 via the UI manager 215.

The API 216 provides programmatic access to one or more functions of the subscription management system 100. For example, the API 216 may provide a programmatic interface to one or more functions of the subscription management system 100 that may be invoked by one of the other programs 230 or some other module. In this manner, the API 216 facilitates the development of third-party software, such as user interfaces, plug-ins, news feeds, adapters (e.g., for integrating functions of the subscription management system 100 into Web applications), and the like. In addition, the API 216 may be in at least some embodiments invoked or otherwise accessed via remote entities, such as one of the content sources 255, to access various functions of the subscription management system 100. For example, one of the content sources 255 may upload or otherwise provide content associated with a subscription via the API 216.

The data store 106 is used by the other modules of the subscription management system 100 to store and/or communicate information. As discussed above, the components of the system 100 use the data store 106 to record various types of information, including content, information about users, additions received from users, and the like. Although the components of the system 100 are described as communicating primarily through the data store 106, other communication mechanisms are contemplated, including message passing, function calls, pipes, sockets, shared memory, and the like.

The subscription management system 100 interacts via the network 250 with the content sources 255 and the portable devices 110. The network 250 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The portable devices 110 include mobile phones, smart phones, personal digital assistants, laptop computers, tablet computers, and the like. In other embodiments, other types of computing devices may be used to receive subscriptions and provide additions, including desktop computers, kiosk computers, and the like.

In an example embodiment, components/modules of the subscription management system 100 are implemented using standard programming techniques. For example, the subscription management system 100 may be implemented as a “native” executable running on the CPU 203, along with one or more static or dynamic libraries. In other embodiments, the subscription management system 100 may be implemented as instructions processed by a virtual machine that executes as one of the other programs 230. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the subscription management system 100, such as in the data store 106, can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 106 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the subscription management system 100 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

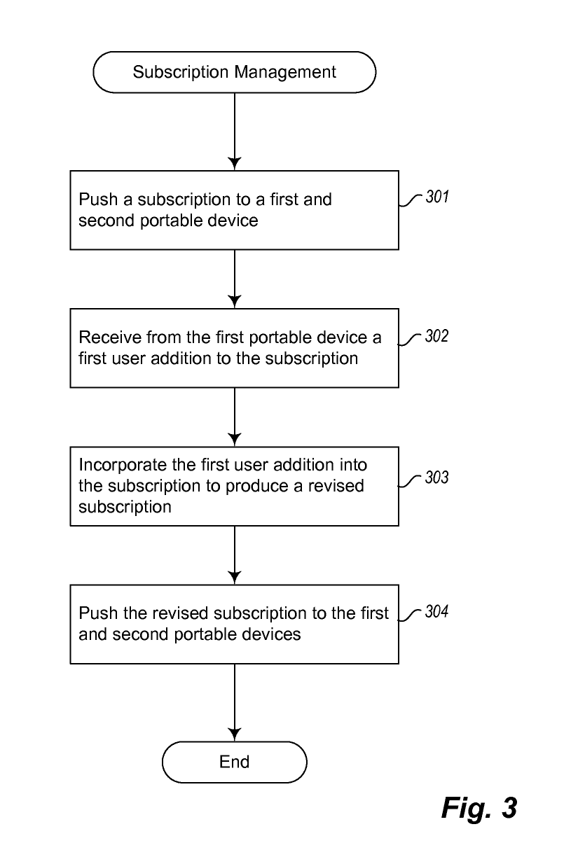

FIG. 3 is a flow diagram of a subscription management process performed by a first example embodiment. In particular, FIG. 3 illustrates a process that may be implemented by, for example, one or more elements of the subscription management system 100, as described above. The process manages the distribution and modification of subscriptions.

The process begins at block 301, where it pushes a subscription to a first and second portable device. Pushing the subscription may include transmitting data associated with the subscription directly or indirectly to the portable devices. Typically, pushing a subscription occurs in the absence of a corresponding request from the portable device, in contrast to other communication protocols, such as poll or pull-based protocols, where data is typically sent in response to a received request.

At block 302, the process receives from the first portable device a first user addition to the subscription. Receiving the addition may include receiving an indication of a change (e.g., addition, substitution, or deletion) to be made to the content of the subscription.

At block 303, the process incorporates the first user addition into the subscription to produce a revised subscription. Incorporating the addition may include reviewing the addition to determine whether it is appropriate to include in the subscription, based on whether the addition includes disparaging language, includes falsehoods, is plagiarized, or the like.

At block 304, the process pushes the revised subscription to the first and second portable devices. After block 304, the process ends.

Some embodiments perform one or more operations/aspects in addition to, or instead of, the ones described with reference to the process of FIG. 3. For example, in one embodiment, a second user can communicate a second user addition to the subscription from the second portable device. More specifically, the process may receive a second user addition from the second portable device; incorporate the received addition into the revised subscription to produce a second revised subscription; and push the second revised subscription to the first and second portable devices.

Other variations are contemplated. For example, a user could contribute multiple additions to one or more subscriptions, and each of the additions could be incorporated into the respective subscription. In some cases, when multiple additions are received (from one or more users), the additions may be “batched” up, such that only one revised subscription is pushed for multiple received additions. Such an approach may reduce network utilization, especially when additions are being received at high frequency. Accordingly, some embodiments define or otherwise determine a window during which multiple received additions will be jointly incorporated into a single revised subscription. For example, the system 100 may dynamically determine an appropriate interval for pushing revised subscriptions, based on various factors such as a specified maximum network utilization, the frequency and size of received additions, a preferred update frequency, and the like. In one example embodiment, the system 100 is configured to push a revised subscription when more than 1% (or some other threshold, such as 50 words) of a subscription is changed or when at least one hour (or other time period) has passed since the subscription was last pushed, such that every small modification (e.g., corrections of typographical errors) does not necessarily cause another revised subscription to be pushed, thereby reducing network utilization.

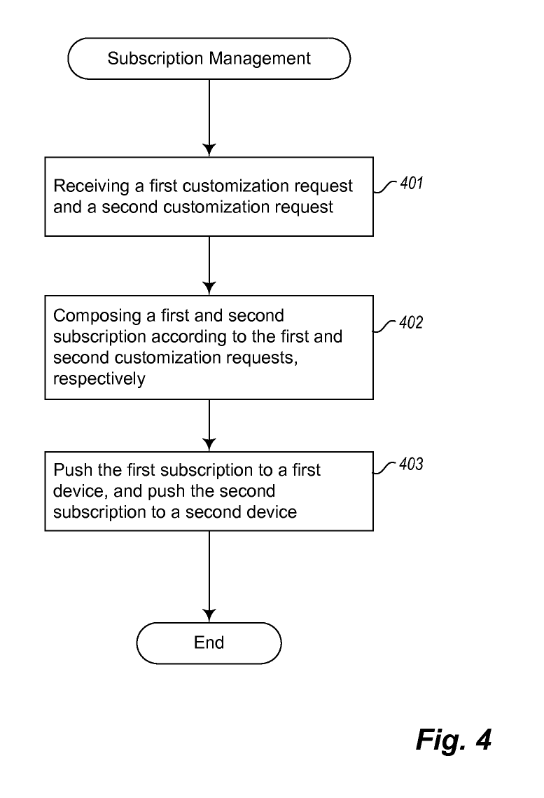

FIG. 4 is a flow diagram of a subscription management process performed by a second example embodiment. In particular, FIG. 4 illustrates a process that may be implemented by, for example, one or more elements of the subscription management system 100, as described above. The process manages the generation and distribution of user-customized subscriptions.

The process begins at block 401, where it receives a first customization request and a second customization request. In some embodiments, the customization requests are received from portable devices that are operated by reader users and that include software for reading subscriptions. In other cases, the customization requests may be received via alternate mechanisms or channels, such as a Web portal, telephone call-in system (e.g., interactive voice response system), or the like.

At block 402, the process composes a first and second subscription according to the first and second customization requests, respectively. In some embodiments, the customization requests include guidelines that specify one or more articles or types of articles to be included in a subscription, such as by indicating a geographic region, a genre, a topic, one or more keywords, or the like. The process then determines one or more content portions (e.g., articles) that match the guidelines of a customization request, and composes those portions into a subscription.

At block 403, the process pushes the first subscription to a first device, and pushes the second subscription to a second device. As noted, the first and second devices may be portable devices operated by users/readers of the subscriptions. After block 403, the process ends.

Some embodiments perform one or more operations/aspects in addition to, or instead of, the ones described with reference to the process of FIG. 4. For example, in some embodiments guidelines of a customization request are implicitly, rather than explicitly, specified. For example, a portable device operated by the user and/or the system 100 may learn over time what types of articles or other content portions are preferred by a user, such as by monitoring or otherwise tracking user behaviors. In one embodiment, the system 100 may record a user's access history, and based on this history, determine what types of articles a user prefers. For example, if a user tends to read baseball and political articles, and tends to avoid weather reports and local news, the system 100 can automatically generate guidelines (or modify existing guidelines) to reflect these preferences, such that the user will in the future receive subscriptions that are better aligned with his interests.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary. It is further contemplated that a subscription could have a plurality of revisions and updates.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “includes,” “including,” “comprises,” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

All of the above-cited references, including Reynolds; Depulch, U.S. Provisional Application No. 61/172,286, entitled “Interactive Digital Media,” and filed on Apr. 24, 2009; and U.S. Provisional Application No. No. 61/174,522, filed on May 1, 2009 and entitled “Interactive Digital Media,” are incorporated herein by reference in their entirety. Where a definition or use of a term in an incorporated reference is inconsistent or contrary to the definition of that term provided herein, the definition of that term provided herein governs and the definition of that term in the reference does not apply.

While the preferred embodiment of the invention has been illustrated and described, as noted above, many changes can be made without departing from the spirit and scope of the invention. For example, although the above techniques have been described primarily with respect to articles and/or textual content, other types of content can be similarly treated, including audio, image, or video content. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method of distributing digital content to a plurality of users, comprising:
receiving a first customization request from a first portable device, and receiving a second customization request from a second portable device;
composing a first subscription according to guidelines of the first customization request;
composing a second subscription according to guidelines of the second customization request, wherein the first and second subscriptions have at least some common content;
pushing the first subscription to the first portable device, and pushing the second subscription to the second portable device;
receiving from the first portable device a first user addition to the first subscription;
incorporating the first user addition into the first and second subscriptions and producing a revised first subscription and a revised second subscription; and
pushing the revised first and second subscriptions to the first and second portable devices, respectively.

2. The method of claim 1, wherein the first and second subscriptions include multiple articles from a digital periodical, wherein the at least some common content includes a common article, and wherein the first user addition specifies a change to the common article.

3. The method of claim 2, wherein incorporating the first user addition includes reviewing the first user addition to determine whether the first user addition is appropriate for incorporation into the common article.

4. A method of distributing digital content to a plurality of users, comprising:
pushing a subscription to a first portable device and a second portable device;
receiving from the first portable device a first user addition to the subscription;
incorporating the first user addition into the subscription and producing a revised subscription; and
pushing the revised subscription to the first and second portable devices.

5. The method of claim 4, wherein the first portable device is a cellular telephone.

6. The method of claim 4, wherein the first portable device is a portable media player.

7. The method of claim 4, wherein the subscription is at least one article of a digital magazine.

8. The method of claim 4, wherein the revised subscription comprises the subscription, the first user addition, and a citation to the first user addition.

9. The method of claim 4, further comprising:
receiving a second user addition from the second portable device;
incorporating the second user addition into the revised subscription to produce a second revised subscription; and
pushing the second revised subscription to the first and second portable devices.

10. The method of claim 4, wherein incorporating the first user addition includes reviewing the first user addition to determine whether the first user addition is appropriate for incorporation into the subscription.

11. The method of claim 10, wherein reviewing the first user addition includes determining whether the first user addition includes disparaging language, has been plagiarized, and/or includes a falsehood.

12. The method of claim 4, further comprising:
receiving a second user addition;
reviewing the second user addition;
determining that the second user addition is not appropriate for incorporation into the subscription; and
rejecting the second user addition.

13. A computing system configured to distribute digital content, comprising:
a memory;
a module stored on the memory that is configured, when executed, to:
push a subscription to a first portable device and a second portable device;
receive from the first portable device a first user addition to the subscription;
incorporate the first user addition into the subscription and producing a revised subscription; and
push the revised subscription to the first and second portable devices.

14. The computing system of claim 13 wherein the module includes software instructions for execution in the memory of the computing system.

15. The computing system of claim 13 wherein the module is a subscription management system.

16. The computing system of claim 13, wherein the first portable device is a cellular telephone or a portable media player.

17. The computing system of claim 13, wherein the subscription is at least one article of a digital magazine, and wherein the revised subscription comprises the subscription, the first user addition, and a citation to the first user addition.

18. A computer-readable storage medium whose contents, when executed, cause a computing system to manage subscriptions, by performing a method comprising:
pushing a subscription to a first portable device and a second portable device;
receiving from the first portable device a first user addition to the subscription;
incorporating the first user addition into the subscription and producing a revised subscription; and
pushing the revised subscription to the first and second portable devices.

19. The computer-readable storage medium of claim 18, wherein incorporating the first user addition includes reviewing the first user addition to determine whether the first user addition is appropriate for incorporation into the subscription.

20. The computer-readable storage medium of claim 19, wherein reviewing the first user addition includes determining whether the first user addition includes disparaging language, has been plagiarized, and/or includes a falsehood.

21. The computer-readable storage medium of claim 19, wherein reviewing the first user addition is performed automatically and without human intervention.

22. The computer-readable storage medium of claim 18, wherein pushing the subscription includes transmitting the subscription via a network to the first and second portable devices.

23. The computer-readable storage medium of claim 18 wherein the computer-readable storage medium is memory in the computing system, and wherein the contents are instructions that are stored on the memory and that, when executed, cause the computing system to perform the method.

24. A method of distributing customized digital content to a plurality of readers, comprising:
receiving a first customization request from a first reader, and receiving a second customization request from a second reader;
composing a first and second subscription according to guidelines of the first and second customization requests, respectively; and
pushing the first subscription to a first portable device, and pushing the second subscription to a second portable device.

25. The method of claim 24, wherein the first and second portable devices are each one of: a cellular telephone, a portable media player, a smart phone, a tablet computer, and a personal digital assistant.

26. The method of claim 24, wherein the first subscription has different components than the second subscription.

27. The method of claim 24, wherein the first subscription has at least some content in common with the second subscription, and further comprising:
receiving a user addition to the common content of the first and second subscription;
incorporating the received user addition into the first and second subscriptions and producing revised first and second subscriptions; and
pushing the revised first and second subscriptions to the first and second portable devices, respectively.

28. The method of claim 24, further comprising:
receiving an updated first customization request from the first reader; pushing a updated first subscription to the first portable device; and
wherein the updated first subscription is composed according to guidelines of the first customization request.

29. The method of claim 24, further comprising:
recording a history of subscription content read by a user of the first portable device;
modifying the guidelines of the first subscription based on the recorded history; and
pushing a subscription based on the modified guidelines to the first portable device.

30. The method of claim 24 wherein receiving the first customization request includes receiving the request from the first portable device, and wherein receiving the second customization request includes receiving the request via an interactive voice response system.
